(19) United States
(12) Patent Application Publication
(10) Pub. No.: US 2016/0042613 A1
(43) Pub. Date: Feb. 11, 2016

(54) Baccarat-like side bet for wagering card games

(71) Applicant: Kathleen Nylund Jackson, Scituate, MA (US)

(72) Inventor: Kathleen Nylund Jackson, Scituate, MA (US)

(73) Assignee: Precedent Gaming, Inc., Scituate, MA (US)

(21) Appl. No.: 14/756,148

(22) Filed: Aug. 7, 2015

Related U.S. Application Data
(60) Provisional application No. 61/999,846, filed on Aug. 7, 2014.

(51) Int. Cl. G07F 17/32

(52) U.S. Cl. CPC G07F 17/3293; G07F 17/3288

(57) ABSTRACT

A method of playing a side bet associated with a wagering card game on a table or electronic device is disclosed. Predetermined cards of an initially-dealt base card game provide fundamental elements of the side bet. Scoring is based on the sum value of the fundamental elements that provides a final sum value. Aces count as a 1 value, ranks 2 through 9 count as their respective face value, and 10s through Kings count as a 10 value. Two distinct consecutive predetermined sum values comprising the sum value of the fundamental elements determine whether the sum value is considered a modulo 10 hand or a natural hand. Predetermined final values of modulo 10 hands and natural hands are determined to be winning final values, and paid according to a predetermined paytable.

### RELATED APPLICATION DATA

This application claims priority from U.S. Provisional Patent Application Ser. No. 61/999,846, filed Aug. 7, 2014, and having the Title BACCARAT-LIKE SIDE BET FOR WAGERING CARD GAMES.

### BACKGROUND OF THE INVENTION

1. Field of the Invention

The present invention relates to wagering games and side bets suitable for use in casinos, gaming establishments, internet sites or mobile devices as a felt table game, an electronic table game, an electronic machine game, or an electronic device game.

2. Background of the Art

Virtuously every card game in a gaming environment (casinos, card rooms, internet gambling sites, for instance) allows for a house edge. The mathematical analysis of a game provides the specific house edge. Since the house has the built-in edge, operators look to have as many hands played per hour as possible to increase the take. Side bets are a lucrative way to substantially raise the house take, since it most usually does not require additional time to deal. The house will increase revenue on a game that already guarantees them positive returns in the long run.

Asian-themed games are immensely popular. In particular baccarat has a large Asian following. Macau has now surpassed Las Vegas as the world's leading gambling venue in terms of revenue, and baccarat is the most popular table game in Macau.

Baccarat is a very simple game, although it sometimes is viewed as mysterious and complicated. In fact, the game of Baccarat is basically a coin toss—heads or tails, player or banker. Players in the table version (the electronic version is played virtually the same way) may wager on either the one player hand or the one banker hand to win, or place a wager that the two hands will tie. Aces count as 1 point, ranks 2 through 9 count as their face value, 10s through Kings count as 0. If the sum value of either of each final hand is 9 or less, that is the final value. If the sum value of either of each final hand is 10 or more, only the right-hand digit is considered (for example, a 7 and an 8 would equal 15, or 5 as a total). This method of counting is known as “sum modulo 10” or just “modulo 10”. Both the player hand and the banker hand are dealt two cards as initial hands. Predetermined rules dictate whether or not either hand receives an extra card or stands, so that there is really no strategy involved. If the player's two-card initial hand is comprised of a non-modulo 10 value of 8 or 9 points (2+6, or 4+5, for example), that hand is considered a “natural”, and automatically wins against a dealer hand that is not a natural. After both hands have been finalized using the predetermined rules, the hands are compared, and the hand with the highest point total wins.

Prior art has taught numerous methods to provide a side bet based on baccarat.

U.S. Pat. No. 8,308,542 (Daines) teaches a method to implement two side bets for the casino card game of Baccarat. The player can choose to bet on a player side bet, a banker side bet, or play both side bets. The player side bet wins if, after the game is resolved, the player point total is one less than the banker point total, and loses in all other situations. The banker side bet wins if, after the game is resolved, the banker point total is one less than the player point total, and loses in all other situations. Subsets of these winning sets can be used as well for the winning combinations.

U.S. Pat. No. 7,404,560 (Chen) describes variations of a baccarat card game that is played with six or eight decks standard 53 playing cards with one joker in each deck. It provides a variety of optional side bets, such as, banker blackjack, banker 21, banker 17, player blackjack, player 21 and player 16 besides the main wagering areas, Banker, Player and Tie. The jokers serve as winning cards.

U.S. Pat. No. 7,309,065 (Yoseloff, et al.) teaches a multi-player automated casino table card game platform that enables play of casino table baccarat-type games according to rules effected through a processor. Rules may include games similar to Baccarat or Mini Baccarat with an optional side bet on a point spread between the player and bank hands.

U.S. Pat. No. 7,114,724 (Ritzer, et al.) discloses a casino gambling card table game in which a player may bet that a next card dealt would provide a selected poker hand and/or a winning baccarat hand.

U.S. Pat. No. 5,702,104 (Malek, et al.) describes a method and apparatus for playing a mixture of Twenty-one and Baccarat. Each player initially receives three cards, one for Twenty-one, one for Baccarat, and one common card to be summed with the Twenty-one card and the Baccarat card. The player then has the option of receiving a second Twenty-one card to be summed with the first Twenty-one card and the common card, and a second Baccarat card to be summed with the first Baccarat card and the common card.

United States Application No. 20140094237 (Massie, et al.) discloses a method to implement a blackjack variation that combines elements of blackjack and baccarat. The player is dealt two cards and can draw an optional third card. The dealer is dealt two cards and would draw a third card based upon predetermined rules. Both hands are scored using baccarat scoring, and the best (highest) hand wins.

United States Application No. 20140018138 (Sloan) discloses a method for playing a card game with hybrid rules, which includes receiving wagers and dealing cards to form two- or three-card hands based on blackjack or poker wagering and dealing rules, valuing and ranking the two- or three-card hands based on modified baccarat valuing and ranking rules wherein a three-card hand outranks a two-card hand of equal sum modulo ten value, and resolving the wagers based on the valuing and ranking of the two- or three-card hands.

United States Application No. 20110042897 (Daines) describes method of playing baccarat that includes a side bet wagering on the outcome of the player's score, the banker's score or a combination of the player's score and banker's score. In one embodiment, the score is derived from the sum of the player's and banker's hand. In another embodiment, the score is derived from the value of the winning hand. In yet another embodiment, the outcomes of the score may be grouped. The side bet may be made on the expected outcome of a score, where the score equals a value which may be a numeral from 0 to 9 inclusive, and which is derived from the baccarat score of the player's hand, the banker's hand, or the sum of the player's hand and the banker's hand. The value is determined using the baccarat counting method.

United States Application No. 20080012221 (Webb) discloses a casino card game that utilizes standard playing cards to define a player hand. A first game component is resolved based on a numerical hand result of the player hand determined according to either a modulo 10 count system or a conventional count system, while a second game component is resolved based on a numerical hand result of the player hand determined according to the other of a modulo 10 count system or a conventional count system. In one operating mode, the first game component is Blackjack, and a wager on the second game component is resolved on the player initial two-card hand based on a modulo 10 count system consistent with the principles of Baccarat.

United States Patent No. 20050218598 (Parsadaian) discloses a combination baccarat and blackjack game wherein each wagering player plays a baccarat-type game and a blackjack-type game against a dealer who also plays baccarat and blackjack hands. In one embodiment, a determination card is utilized in the event of a tie, to determine whether or to what extent a player loses his/her initial wager. A bonus feature may also be provided, to permit players to achieve a bonus payout for achieving particular blackjack and/or baccarat hands. In another embodiment, only one player blackjack hand and one player baccarat hand is provided, with players wagering on dealer or player blackjack hands and/or baccarat hands.

Each of the references discussed in this text art are incorporated herein in their entirety for all purposes including enablement of single and multiplayer platforms and structures for the execution of games.

It is still desirable to create a new and exciting baccarat-like side bet that provides the opportunity for larger payouts than those discussed.

### SUMMARY OF THE INVENTION

A method of providing a baccarat-like side bet for wagering card games utilizes the cards of initially-dealt hands of blackjack, 3-card poker or baccarat. The side bet is resolved against a predetermined paytable. In a base game of blackjack, the two-card player hand in combination with the dealer up card is examined for wins; in 3-card poker, the player's three-card hand, the dealer's three-card hand, or both individually are examined for wins; in baccarat, one community card (preferably dealt from a separate deck) is combined with the player's two-card hand and also separately with the dealer's two-card hand, and then the player's three-card hand, the dealer's three-card hand, or both individually are examined for wins.

The scoring of the three-card hands is based in part on the “sum modulo 10” (or “modulo 10”) point scoring of baccarat. Aces count as a 1 value, ranks 2 through 9 inclusive count as their respective face values, but unlike in baccarat, 10s through Kings inclusive count as a 10 value. If the sum value of the three cards is 9 or less, that is the final value. If the sum value of the three cards is 10 or more, only the right-hand digit is considered (for example, a hand of 7+8+10=25=5 as a final value). Hands of a 3 value through a 9 value without the modulo 10 point count are considered “naturals”, and are automatic wins and paid according to a predetermined paytable. For hands of a 10 value or more requiring the modulo 10 count, only predetermined hands (8s and 9s for example) are winning hands and paid according to the predetermined paytable. For example, a hand of A+2+3=6 is a natural, and a hand of 2+5+9=16=6 is a modulo 10 count hand.

### BRIEF DESCRIPTION OF THE FIGURES

FIG. 1A shows a base game of blackjack at an initial deal stage.

FIG. 1B shows the base game of blackjack at a side bet resolution stage.

FIG. 2A shows a base game of 3-card poker at an initial deal stage.

FIG. 2B shows the base game of 3-card poker at a first side bet resolution stage.

FIG. 2C shows the base game of 3-card poker at a second side bet resolution stage.

FIG. 3A shows a base game of baccarat at an initial deal stage.

FIG. 3B shows the base game of baccarat at a side bet resolution stage.

### DETAILED DESCRIPTION OF THE INVENTION

A method of playing a wagering card game and providing a side bet uses at least one deck of 52 standard playing cards having thirteen ranks (2, 3, 4, 5, 6, 7, 8, 9, 10, J, Q, K, A) and four suits (Hearts, Diamonds, Spades, Clubs). The wager or wagers may consist of money, monetary credits/points or non-monetary credits/points. The game is played on a felt table utilizing physical playing cards, or it may be an electronic game on a gaming system that comprises: at least one processor; a gaming apparatus having at least one input device and at least one display device; and at least one memory device which stores a plurality of instructions. The game may be played on at least a casino gaming table, a casino gaming machine, a personal computer or pad, an internet gaming site, or as a mobile application. In the case of a table game format, the decks may be shuffled by either an electronic shuffling machine or an electronic continuous shuffler, in order to provide a random deal of the cards and as a prevention to card-counting. An electronic format requires the use of a Random Number Generator, or RNG, in order to provide a random deal result.

The present invention preferably comprises a base game of blackjack, 3-card poker or baccarat, although other base games are within the scope thereof. A side bet using a baccarat-like counting method is provided, the side bet being either optional or mandatory, and wagered before any deal of the cards in the base game. A wager on the base game may or may not be required in order to wager on the side bet. The side bet is resolved utilizing at least two of the cards in the initial hand(s) of the base game, although three cards are preferably used, and against a predetermined paytable. For the sake of clarity in understanding the principles of the present invention, the embodiments herein teach exactly three cards in the base game that are fundamental elements for the resolution of the side bet. It should be appreciated that only two or more than three cards may be considered as the fundamental elements for the resolution of the side bet, and base games other than blackjack, 3-card poker and baccarat (i.e., 4-Card Poker, Texas Hold'Em, etc.) are within the scope of the present invention.

The side bet of the present invention is preferably resolved before any additional play of the base game after the initial deal, although, depending upon the base game rules, a resolution of the side bet may occur after any additional play of the base game. There are no decisions to be made by a player in the resolution of the side bet, and since the side bet does not require any decisions and is resolved and scored against a predetermined paytable, the side bet does not relate to the base game. The scoring of the side bet is a singular event that does not influence the play or strategy of the base game.

Predetermined cards of an initially-dealt base card game provide fundamental elements of the side bet. For instance, in a blackjack game, the fundamental elements may be the two initial cards in the player hand, plus the one dealer up card, providing the three cards that determine the resolution of the side bet. Scoring is based on the sum value of the fundamental elements that provides a final value, and the final value is resolved against a predetermined paytable. Aces count as a 1 value, ranks 2 through 9 inclusive count as their respective face value, but unlike in baccarat, 10s through Kings inclusive count as a 10 value. The scoring of the side bet is based in part on the sum modulo 10 model of mathematics. Each sum value is defined as comprising either a “modulo 10 hand”, or a “natural hand”. A modulo 10 hand ignores any tens-column digit, with only the ones-column digit comprising the final value (i.e., 14=4 final value). The final value of a natural hand is the final value of the cards (i.e., A+A+2=4 final value). Two distinct consecutive predetermined values comprising the sum value of the fundamental elements determine whether the hand is considered a modulo 10 hand or a natural hand. For example, a modulo 10 hand may be defined as having a sum value of 12 or more, and a natural hand may be defined as having a sum value of 11 or less. Predetermined final values of either a modulo 10 hand or a natural hand are determined to be winning final values, and paid according to the predetermined paytable.

In a preferred embodiment of the present invention, the sum value of a natural hand is 9 or less (for example, A+3+4=8 final value), and the sum value of a modulo 10 hand is 10 or more (for example, K+8+4=22=2 final value). Final natural hands of 3 to 9 inclusive are winning hands, and final modulo 10 hands of 8 or 9 are winning hands.

Specific embodiments of the present invention are shown below and disclosed according to the base game.

### Blackjack

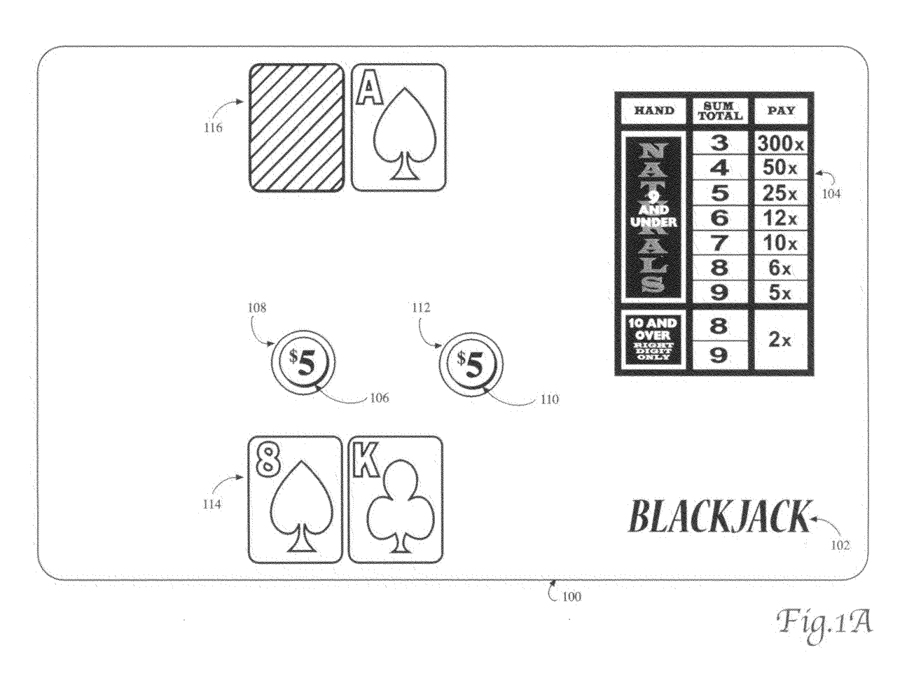

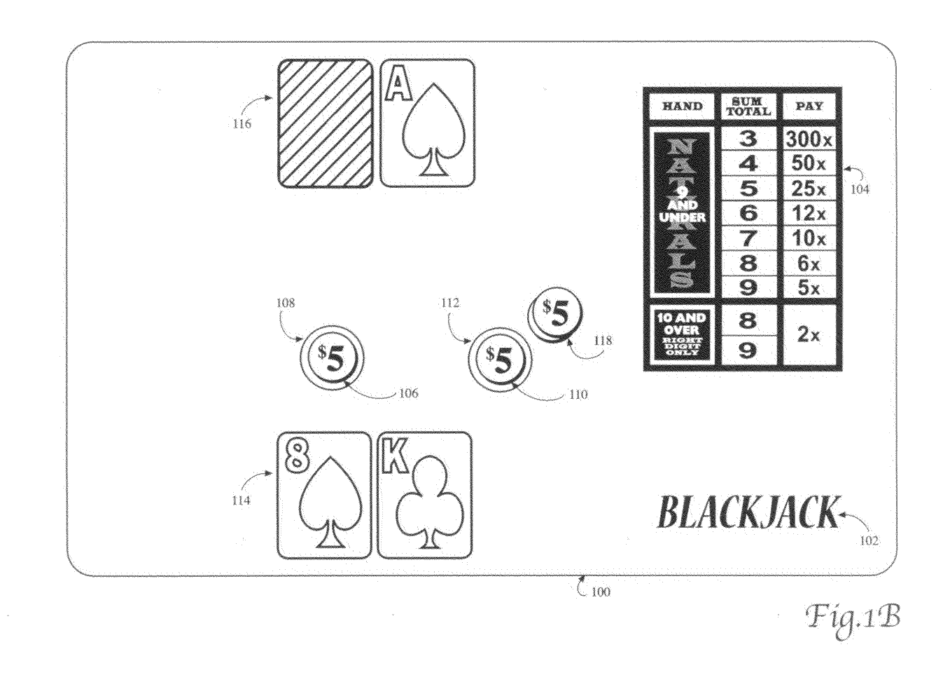

In a first embodiment of the present invention, a base game of a blackjack card game is played utilizing from one to eight standard decks of cards. A player preferably places a wager to play the base game, and at the same time may place a side bet wager. The side bet wager may or may not be equal to the base game wager, may or may not be mandatory, and may or may not require a base game wager in order to play. Two cards are dealt face up to the player, and one face-up card and one face-down card are dealt to the dealer. The two player cards plus the one dealer up card (three cards total) are the fundamental elements to be considered in resolving the side bet. Aces count as a 1 value, ranks 2 through 9 count as their respective face value, but unlike in baccarat, 10s through Kings count as a 10 value. The sum of the three card values is calculated, and the sum value is then determined to be a natural hand if the sum value is 9 or less, or a modulo 10 hand if the sum value is 10 or more. A natural hand with a sum value of 3, 4, 5, 6, 7, 8, or 9 provides a final value that is a winning value and is paid according to a first predetermined paytable. In this first embodiment, the paytable provided is a sample paytable, and the award values may change according to a mathematical analysis and a house hold requirement. The said first predetermined paytable provides increasingly larger rewards from a natural 9 final value to a natural 3 final value. Each award for a natural final value is based on the frequency of the particular value: a natural 9 is the most common of natural final values, and a natural 3 is the rarest of natural final values. A modulo 10 hand with a sum value of 10 or more utilizes the right-hand or ones-column digit only as a final value, and a final value of 8 or 9 is a winning value and is paid according to the said first predetermined paytable. The said first predetermined paytable provides the same award for a modulo 10 8 or 9 final value, since the frequencies of those said final values are similar. It should be noted that two separate awards may be provided for a modulo 10 8 final value and a modulo 9 final value. References to FIGS. 1A and 1B will assist in further understanding of the practice of the present invention.

FIG. 1A shows a felt table layout (or alternately a player monitor screen) 100 according to the first embodiment of the present invention, displaying the name of the base game 102 and a sample paytable 104 for a three-card side bet. The paytable defines naturals as having a final sum value of 9 and under, with increasingly larger awards for 9s through 3s inclusive, and modulo 10 hands as having a final sum value of 10 or over, with awards for an 8 or a 9. A single player places a $5 wager 106 on the betting circle area 108 in order to play the blackjack base game, and a $5 wager 110 on the betting circle 112 in order to play the side bet. The player is dealt an initial 2-card hand 114 comprising an 8 of Spades and a King of Clubs. The dealer is dealt an initial 2-card hand 116 comprising an up card of an Ace of Spades and a down card. The two player cards plus the dealer up card are the fundamental elements for the resolution of the side bet.

FIG. 1B shows the elements of FIG. 1A with a final resolution of the side bet before any additional play of the blackjack game. Since the sum value of the fundamental elements (the 8 of Spades, the King of Clubs and the Ace of Spades) equals 19, it is considered a modulo 10 hand. The final value is 9, and the player is paid 2× the wager, or $10 118 according to the sample paytable 104.

### 3-Card Poker

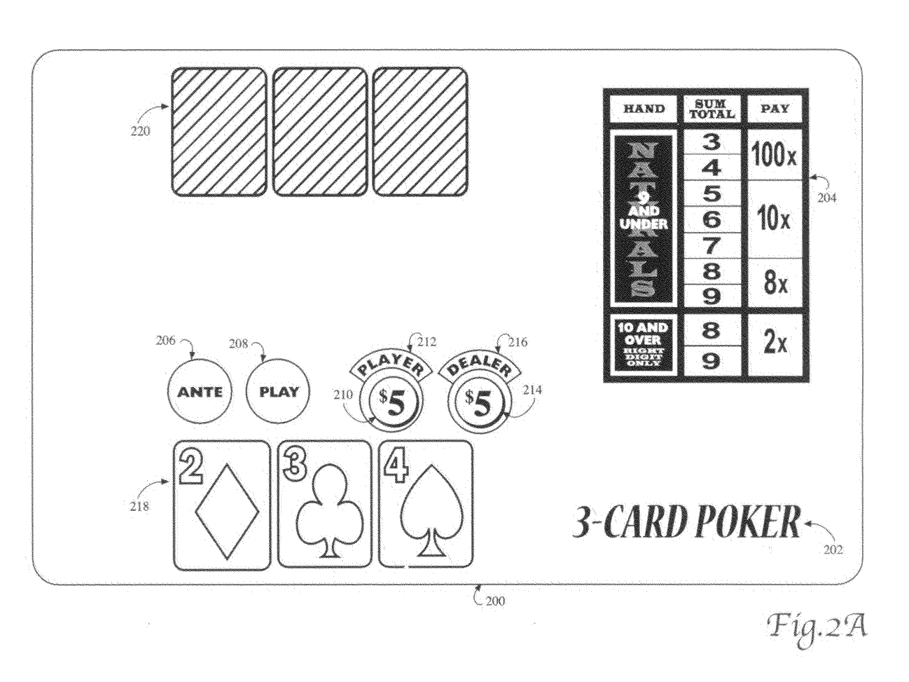

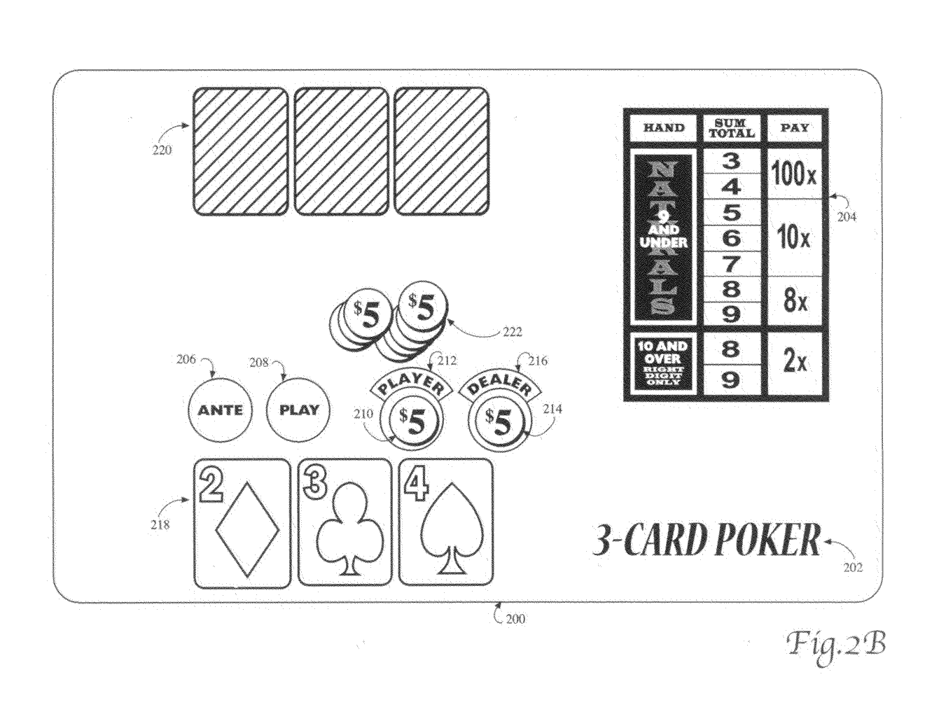

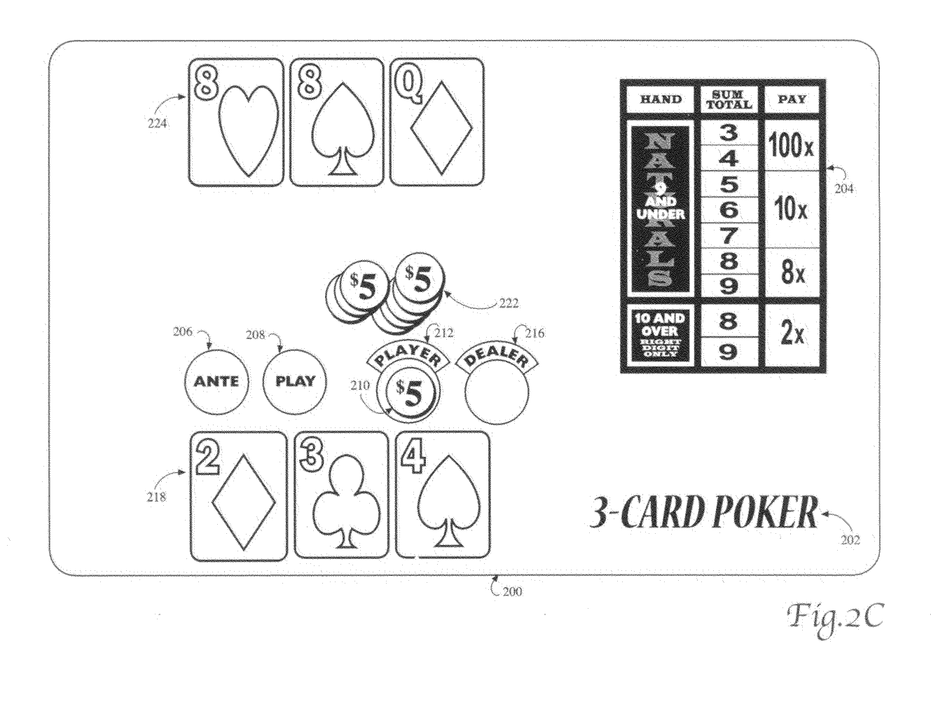

In a second embodiment of the present invention, a base game of a 3-card poker card game is played utilizing from one to eight standard decks of cards. A player preferably places an Ante wager to play the base game, and at the same time may place a side bet wager on the player hand and/or a dealer hand (differing from the traditional Pair Plus® side wager). The side bet wager may or may not be equal to the base game wager, may or may not be mandatory, and may or may not require a base game wager in order to play. Three cards are dealt face up to the player, and three cards are dealt face down to the dealer. The three player cards and/or the three dealer cards are the fundamental elements to be considered in resolving the side bet. Aces count as a 1 value, ranks 2 through 9 count as their respective face value, but unlike in baccarat, 10s through Kings count as a 10 value. If the player has made a side bet on the player hand, that said side bet is then resolved before additional play of the base game hand. If the player has placed an Ante wager, the player then decides to either fold his three-card poker hand or play his hand by making a Play wager. The dealer then reveals his three cards, and the base game is resolved according to the rules of the base game. If the player has placed a side bet on the dealer hand, that said side bet is then resolved. The resolution of each side bet (player hand or dealer hand) comprises the sum value of the three card values, and the sum value is then determined to be a natural hand if the sum value is 9 or less, or a modulo 10 hand if the sum value is 10 or more. A natural hand with a sum value of 3, 4, 5, 6, 7, 8, or 9 provides a final value that is a winning value and is paid according to a second predetermined paytable. In this second embodiment, the said second paytable provided is a sample paytable, and the award values may change according to a mathematical analysis and a house hold requirement. The said second predetermined paytable provides increasingly larger rewards from a natural 9 or 8 final value, to a natural 7, 6, or 5 final value, to a natural 4 or 3 final value. Each award for a natural final value is based on the frequency of the particular value: a natural 9 is the most common of natural final values, and a natural 3 is the rarest of natural final values. A modulo 10 hand with a sum value of 10 or more utilizes the right-hand or ones-column digit only as a final value, and a final value of 8 or 9 is a winning value and is paid according to the said second predetermined paytable. The said second predetermined paytable provides the same award for a modulo 10 8 or 9 final value, since the frequencies of those said final values are similar. It should be noted that two separate awards may be provided for a modulo 10 8 final value and a modulo 9 final value. References to FIGS. 2A, 2B and 2C will assist in further understanding of the practice of the present invention.

FIG. 2A shows a felt table layout (or alternately a player monitor screen) 200 according to the second embodiment of the present invention, displaying the name of the base game 202 and a sample paytable 204 for a three-card side bet. The paytable defines naturals as having a final sum value of 9 and under, with increasingly larger awards for 9s and 8s, to 7s through 5s, to 4s and 3s. Modulo 10 hands are defined as having a final sum value 10 or over, with awards for a final sum value of 8 or 9. In this example, the player has chosen not to wager on the base game (206 and 208). A single player has chosen to place a $5 wager 210 on the Player betting circle area 212 and a $5 wager 214 on the Dealer betting circle 216 in order to play both side bets. The player is dealt an initial 3-card hand 218 comprising a 2 of Diamonds, a 3 of Clubs, and a 4 of Spades. The dealer is dealt an initial 3-card hand 220 comprising three down cards. The three player cards and separately the three dealer cards are the fundamental elements for the resolution of the side bets.

FIG. 2B shows the elements of FIG. 2A with a final resolution of the Player side bet before any additional play of the 3-Card Poker game. Since the sum value of the fundamental elements (the 2 of Diamonds, the 3 of Clubs, and the 4 of Spades) equals 9, it is considered natural. The final value is 9, and the player is paid 8× the wager, or $40 222 according to the sample paytable 204.

FIG. 2C shows the elements of FIG. 2B with a final resolution of the Dealer side bet after the final play of the 3-Card Poker game. The dealer hand of an 8 of Hearts, an 8 of Spades, and a Queen of Diamonds is revealed 224, and since the sum value of the fundamental elements equals 16=6 final value, it is considered a modulo 10 hand. The final value is 6, and the player loses according to the sample paytable 204.

### Baccarat

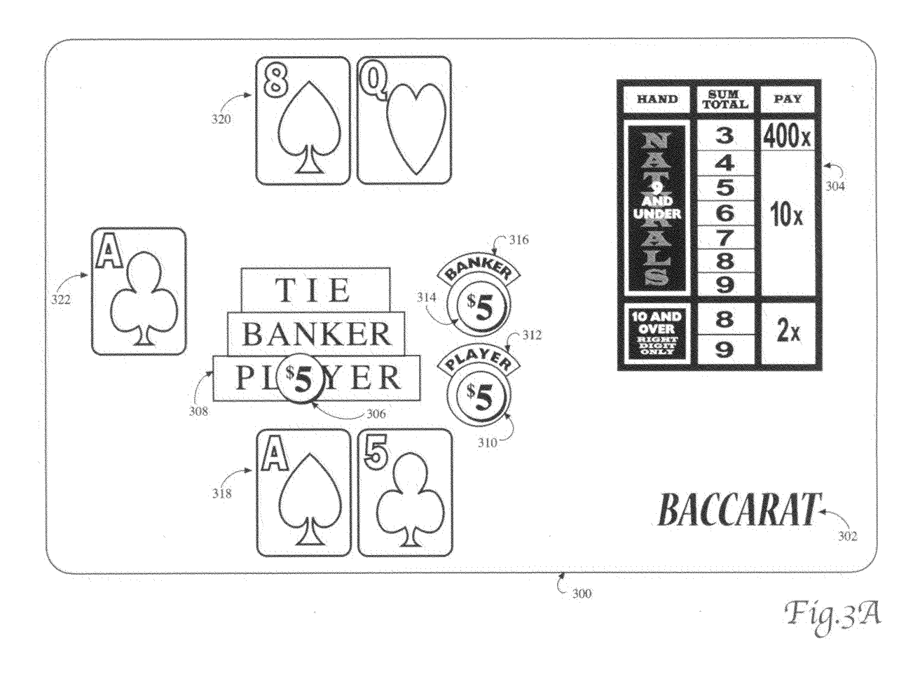

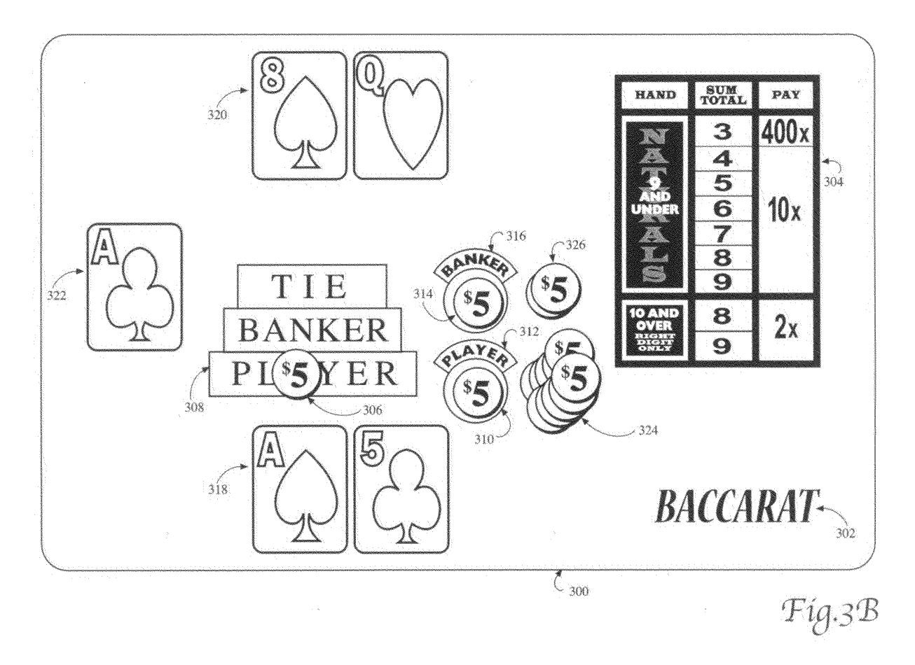

In a third embodiment of the present invention, a base game of a baccarat card game or a mini-baccarat game is played utilizing from one to eight standard decks of cards. A player preferably places a wager to play the base game on a player hand to win, a banker hand to win, or a tie between the player and the banker hand, and at the same time may place a side bet wager. The side bet wager may or may not be equal to the base game wager, may or may not be mandatory, and may or may not require a base game wager in order to play. Two cards are dealt to the player, and two cards are dealt to the banker. The cards in each of the two hands are either dealt face up, or immediately revealed before further play of the base game. One card is additionally dealt as a community card that is combined with each of the two-card hands. It is preferred that the community card is dealt from a separate deck so as to not interrupt the flow of the cards in the base game. The two player cards plus the community card (three cards total) and/or the two banker cards plus the community card (three cards total) are the fundamental elements to be considered in resolving the side bet. Aces count as a 1 value, ranks 2 through 9 count as their respective face value, but unlike in baccarat, 10s through Kings count as a 10 value. Before any additional play of the base game, the sum of the three card values is calculated for the both the player hand and the dealer hand, and the sum value of each is then determined to be a natural hand if the sum value is 9 or less, or a modulo 10 hand if the sum value is 10 or more. A natural hand with a sum value of 3, 4, 5, 6, 7, 8, or 9 provides a final value that is a winning value and is paid according to a third predetermined paytable. In this third embodiment, the said predetermined third paytable provided is a sample paytable, and the award values may change according to a mathematical analysis and a house hold requirement. The said third predetermined paytable provides one award value for a natural 9 final value to a natural 4 final value, inclusive. The award value for a natural final value of 4, 5, 6, 7, 8, or 9 is based on the frequency of the particular values and the averaging thereof. A natural 3, being the rarest final value, is awarded a highest award. A modulo 10 hand with a sum value of 10 or more utilizes the right-hand or ones-column digit only as a final value, and a final value of 8 or 9 is a winning value and is paid according to the said third predetermined paytable. The said third predetermined paytable provides the same award for a modulo 10 8 or 9 final value, since the frequencies of those said final values are similar. It should be noted that two separate awards may be provided for a modulo 10 8 final value and a modulo 10 9 final value. References to FIGS. 3A and 3B further explain the present invention.

FIG. 3A shows a felt table layout (or alternately a player monitor screen) 300 according to the third embodiment of the present invention, displaying the name of the base game 302 and a sample paytable 304 for a three-card side bet. The paytable defines naturals as having a final value of 9 and under, with same awards for 9 to 4 inclusive and the largest award for 3, and modulo 10 hands as having a final value of 10 or over, with awards for a final value of 8 or 9. A single player places a $5 wager 306 to bet the Player on the baccarat betting area 308 in order to play the baccarat base game, a $5 wager 310 on the Player betting circle 312 and a $5 wager 314 on the Banker betting circle 316 in order to play both side bets. From a predetermined deck of cards, the player is dealt an initial 2-card hand 318 comprising an Ace of Spades and a 5 of Clubs. The dealer is dealt an initial 2-card hand 320 comprising an 8 of Spades and a Queen of Hearts (both hands are shown revealed). One community card 322 comprising the Ace of Clubs is dealt face up from a deck of cards separate from the predetermined base game deck of cards. The two player cards plus the one community card are the fundamental elements for the resolution of the Player side bet. The two dealer cards plus the one community card are the fundamental elements for the resolution of the Banker side bet. It should be noted that the one community card may instead be two separate cards that are dealt singularly to the player and singularly to the dealer, and preferably dealt from a deck of cards separate from the predetermined base game deck of cards.

FIG. 3B shows the elements of FIG. 3A with a final resolution of the side bets before any additional play of the baccarat game. Since the sum value of the fundamental elements of the player hand (the Ace of Spades, the 5 of Clubs, and the Ace of Clubs) equals 7, it is considered natural. The final value is 7, and the player is paid 10× the wager, or $50 324 according to the sample paytable 304. Since the sum value of the fundamental elements of the banker hand equals 19, it is considered a modulo 10 hand. The final value is 9, and the player is paid 2× the wager, or $10 326 according to the sample paytable 304.

It is contemplated that the side bet may in alternate embodiments comprise cards of a base game that may be dealt initially and as part of the base game gameplay. In addition, only two predetermined cards may be the fundamental elements to be considered in resolving the side bet. As an example, in a base game of Texas Hold'Em, the community cards comprising the “flop” and the “turn” may determine the cards for resolving the side bet. Since the chance of those two cards summing 9 or less is necessarily higher than with three cards, the paytable would reflect smaller awards if the distinct predetermined values of the sum of the fundamental elements for determining whether the hand is a modulo 10 hand is 10 or more or a natural hand is 9 or less. Alternately, the two distinct predetermined values of the sum of the fundamental elements that determine whether the hand is a modulo 10 hand or a natural hand may be 7 or more and 6 or less respectively.

It is also contemplated that the side bet may in alternate embodiments have initial hands of a base game in which four (or more) predetermined cards are the fundamental elements to be considered in resolving the side bet. As an example, in a base game of Four Card Poker®, the final player hand, the final dealer hand, or the last four cards dealt in the dealer hand may determine the cards for resolving the side bet. Since the chance of those four cards summing 9 or less is necessarily lower than with three cards, the paytable would reflect larger awards with less frequency if the distinct predetermined values of the sum of the fundamental elements for determining whether the hand is a modulo 10 hand is 10 or more or a natural hand is 9 or less. Alternately, the two distinct predetermined values of the sum of the fundamental elements that determine whether the hand is a modulo 10 hand or a natural hand may be 15 or more and 14 or less respectively.

The above embodiments provide the basis of the gameplay for both physical table games and electronic versions of the present invention. The various components of the electronic table or gaming machine are controlled by a central processing unit (CPU), also referred to herein as a controller or processor (such as a microcontroller or microprocessor). To provide gaming functions, the controller executes one or more game programs stored in a computer readable storage medium, in the form of memory. The controller performs the random selection using a random number generator (RNG) of an outcome from the plurality of possible outcomes of the wagering game. Alternatively, the random event may be determined at a remote controller. The remote controller may either use an RNG or a pooling scheme for its central determination of a game outcome. It should be noted that the controller may include one or more microprocessors, including, but not limited to, a master processor, a slave processor, and a secondary or parallel processor.

The controller is also coupled to the system memory and a money/credit detector. The system memory may comprise a volatile memory (e.g., a random-access memory [RAM]) and a non-volatile memory (e.g., an EPROM). The system memory may include multiple RAM and multiple program memories. The money/credit detector signals the processor that money and/or credits were input via the value input device. Preferably, these components are located within the housing of the gaming machine. However, as explained above, these components may be located outboard of the housing and connected to the remainder of the components of the gaming machine via a variety of different wired or wireless connection methods.

The controller is also connected to, and controls, the primary display, the player input device, and a payoff mechanism. The payoff mechanism is operable, in response to instructions from the controller, and, awards a payoff to the player in response to certain winning outcomes that might occur in the basic game or the bonus game(s). The payoff may be provided in the form of points, bills, tickets, coupons, cards, etc. For example, the payoff mechanism may include both a ticket printer and a coin outlet. However, any of a variety of payoff mechanisms well known in the art may be implemented, including cards, coins, tickets, smartcards, cash, etc. One or more pay tables stored in the system memory determine the payoff amounts distributed by the payoff mechanism.

Communications between the controller and both the peripheral components of the gaming machine and external systems occur through input/output (I/O) circuits. More specifically, the controller directs and receives inputs from the peripheral components of the gaming machine through the input/output circuits. Further, the controller communicates with the external systems via the I/O circuits and a communication path (e.g., serial, parallel, IR, RC, 10bT, etc.). The external systems may include a gaming network, other gaming machines, a gaming server, communications hardware, or a variety of other interfaced systems or components. Even though the I/O circuits may be shown as a single block, it should be noted that each of the I/O circuits may include different types of I/O circuits.

Controller, as used herein, comprises any combination of hardware, software, and/or firmware that may be disposed or reside inside and/or outside the gaming machine that may communicate with and/or control the transfer of data between the gaming machine and a bus, another computer, processor, or device and/or a service and/or a network. The controller may comprise one or more controllers or processors. The controller may, alternatively, comprise a CPU in combination with other components, such as the I/O circuits and the system memory.

Although specific examples and specific rules have been provided in this discussion, these specifics are intended to be only support for the generic concepts of the invention and are not intended to be absolute limits in the scope of the technology discussed.

What is claimed:

1. A method of providing a side bet associated with a base wagering card game for at least one player comprises steps to:
a) enable a player to place at least one wager on at least one side bet associated with a base wagering card game;
b) establish an initial deck of playing cards comprised of standard ranks and suits to be used in the play of the base wagering card game;
c) determine a set of predetermined cards from a set of initially-dealt cards in the base wagering card game, wherein the set of predetermined cards provides fundamental elements of the at least one side bet;
d) determine a sum value of the fundamental elements;
e) determine whether the sum value comprises either a modulo 10 count or a conventional count according to two distinct consecutive predetermined sum values;
f) determine a final value based on either the modulo 10 count or the conventional count;
g) establish a predetermined paytable associated with the at least one side bet wherein a first pay category is determined by a modulo 10 final value, and a second pay category is determined by a conventional count value;
h) provide a predetermined at least one final value in each pay category that determines a winning value; and
i) resolve the at least one side bet according to the predetermined paytable.

2. The method of claim 1 wherein a base card game wager is mandatory when placing the at least one side bet wager.

3. The method of claim 1 wherein a base card game wager is not mandatory when placing the at least one side bet wager.

4. The method of claim 1 wherein the at least one side bet is resolved before any additional play of the base card game after an initial deal, during any additional play of the base card game after an initial deal, or after any additional play of the base card game after an initial deal.

5. The method of claim 1 wherein the base card game is Blackjack, wherein the initially-dealt cards comprise two face-up player cards and two dealer cards that are dealt as one card up and one card down.

6. The method of claim 5 wherein the two player cards in addition to the one dealer up card comprise the fundamental elements of the side bet.

7. The method of claim 1 wherein the base card game is 3-Card Poker, wherein the initially-dealt cards comprise three player cards and three dealer cards.

8. The method of claim 7 wherein the three player cards and/or the three dealer cards comprise the fundamental elements of the at least one side bet.

9. The method of claim 1 wherein the base card game is Baccarat, wherein the initially-dealt cards comprise two player cards and two dealer cards, plus one additional community card.

10. The method of claim 9 wherein two player cards plus the one community card, and/or the three dealer cards plus the one community card comprise the fundamental elements of the at least one side bet.

11. A method of providing a side bet associated with a base wagering card game for at least one player on a gaming system comprises: at least one processor; a gaming apparatus having at least one input device and at least one display device; at least one memory device which stores a plurality of instructions which, when executed by the at least one processor, cause the at least one processor to operate with the at least one display device and the at least one input device to provide the steps to:
a) enable a player to place at least one wager on at least one side bet associated with a base wagering card game;
b) establish an initial deck of playing cards comprised of standard ranks and suits to be used in the play of the base wagering card game;
c) determine a set of predetermined cards from a set of initially-dealt cards in the base wagering card game, wherein the set of predetermined cards provides fundamental elements of the at least one side bet;
d) determine a sum value of the fundamental elements;
e) determine whether the sum value comprises either a modulo 10 count or a conventional count according to two distinct consecutive predetermined sum values;
f) determine a final value based on either the modulo 10 count or the conventional count;
g) establish a predetermined paytable associated with the at least one side bet wherein a first pay category is determined by a modulo 10 final value, and a second pay category is determined by a conventional count value;
h) provide a predetermined at least one final value in each pay category that determines a winning value; and
i) resolve the at least one side bet according to the predetermined paytable.

12. The method of claim 1 wherein a base card game wager is mandatory when placing the at least one side bet wager.

13. The method of claim 11 wherein a base card game wager is not mandatory when placing the at least one side bet wager.

14. The method of claim 11 wherein the at least one side bet is resolved before any additional play of the base card game after an initial deal, during any additional play of the base card game after an initial deal, or after any additional play of the base card game after an initial deal.

15. The method of claim 11 wherein the base card game is Blackjack, wherein the initially-dealt cards comprise two face-up player cards and two dealer cards that are dealt as one card up and one card down.

16. The method of claim 15 wherein the two player cards in addition to the one dealer up card comprise the fundamental elements of the side bet.

17. The method of claim 11 wherein the base card game is 3-Card Poker, wherein the initially-dealt cards comprise three player cards and three dealer cards.

18. The method of claim 17 wherein the three player cards and/or the three dealer cards comprise the fundamental elements of the at least one side bet.

19. The method of claim 11 wherein the base card game is Baccarat, wherein the initially-dealt cards comprise two player cards and two dealer cards, plus one additional community card.

20. The method of claim 19 wherein the two player cards plus the one community card, and/or the three dealer cards plus the one community card comprise the fundamental elements of the at least one side bet.
